(19) United States
(12) Patent Application Publication
(10) Pub. No.: US 2020/0156682 A1
(43) Pub. Date: May 21, 2020

(54) HAND TRUCK

(71) Applicant: FOREST MASTER LIMITED, Tyne and Wear (GB)

(72) Inventor: Andrew MARTIN, Tyne and Wear (GB)

(21) Appl. No.: 16/604,260

(22) PCT Filed: Apr. 6, 2018
(86) PCT No.: PCT/GB2018/050925

§ 371 Date: Oct. 10, 2019

(30) Foreign Application Priority Data
Apr. 10, 2017 (GB) 1705729.0

(51) Int. Cl. B62B 1/12

(52) U.S. Cl. CPC B62B 1/12; B62B 2205/30; B62B 2301/20; B62B 2301/10

(57) ABSTRACT

A hand truck (10) comprises a frame (12), a platform (14) for carrying a load, an axle (26), two wheels (16) mounted on the axle (26), axle guide members (42), and biasing means (30). The axle (26) is moveable along the axle guide members (42) to move the axle (26) relative to the platform (14). The biasing means (30) compresses to resist tilting of the hand truck (10).

This invention relates to hand trucks, and particularly, but not exclusively, to a hand truck having a wheel axle which is moveable relative to the hand truck's load platform.

Hand trucks, which are also known as hand trolleys, hand carts, sack trucks and dollies are in common usage for lifting and transporting heavy or awkward loads from place to place.

Hand trucks operate as levers which allow a user to generate a moment sufficient to lift a load placed on a platform of the hand truck that might otherwise be too heavy or awkward to lift. However, if a load is particularly heavy, or a user is unable to easily or safely generate a moment large enough to lift a load as a result of being shorter or less physically capable, another user or different machine may be required to move the load.

Adaptations of the commonly-known hand truck exist that include additional mechanisms, such as additional sets of wheels on frames pivotable relative to the hand truck to allow negotiation of stairs, and lever-action arrangements of struts that enable the hand truck's centre of gravity to be altered. These adaptations all contribute a significant increase to both the weight and the cost of the hand truck.

WO 2007/070950 A1 discloses a hand trolley having a wheel assembly and frame supported by the wheel assembly, the wheel assembly and frame being so made and arranged that when the frame is located in an unloading position the wheels may adopt a raised position relative to the surface on which the trolley is positioned. A latch is provided to hold the wheel assembly in the raised position. This hand trolley requires a complicated and relatively heavy arrangement of pivotally connected rigid members to achieve a mechanical advantage during tilting of the trolley to lift a load.

U.S. Pat. No. 4,762,333 discloses a two-wheeled hand truck having wheel-supporting brackets pivotally connected to a frame in a manner to permit movement of the wheels from a first load-supporting position, for supporting loads with a relatively lower centre of gravity, to a second load-supporting position, for supporting loads with a relatively higher centre of gravity. A user is required to apply a force with their foot to act against a locking force provided by a piston rod/gas cylinder arrangement to move the truck between these two positions.

WO 2015/167322 A1 discloses a hand truck with a wheel axle which slides along a guide, a moving arm attached to the axle, and a pair of springs attached between the moving arm and a frame of the hand truck. As the hand truck is tilted, the axle moves along the guide until it meets a high stop. Subsequent tilting causes the springs to expand.

A disadvantage of this arrangement is that, due to each spring expanding in response to tilting of the hand truck, a large amount of space must be allocated to the moving parts of the hand truck so that the springs can expand without interference. A further disadvantage is that expanding springs are more prone to failure than compressed springs: for example, an expanding spring may pass its elastic limit and expand plastically, never returning to its original length.

A further disadvantage is that expanding springs can never function as a hard stop themselves, in contrast to a compressed spring, which is able to once the coils thereof meet one another under compression.

CN103612651A1 discloses a hand truck comprising a carrier plate, an axle, and a pair of expandable springs. The springs are connected between the carrier plate and the axle. Tilting of the hand truck causes the axle to move along a sliding groove, which causes the springs to expand. The springs are configured to be expandable from an initial configuration, in which the axle is at the bottom of the groove, to a second configuration, in which the axle has slid to the top of the groove due to tilting of the hand truck. The springs are therefore not configured to be compressible by tilting of the hand truck to bias the axle away from the platform.

U.S. Pat. No. 1,341,171A discloses a hand truck having an axle whose ends are arranged to slide along an arc-shaped guideway as the hand truck is tilted. Recesses are included in the guideways to restrain the axle so that he hand truck can be stably maintained in its upright position. No means for providing a restoring force to assist in returning the hand truck to the upright configuration is disclosed.

JPS5437671U discloses a hand truck having an axle arranged in a guide channel such that tilting of the hand truck causes the axle to slide along the channel. No means for providing a restoring force to assist in returning the hand truck to the upright configuration is disclosed.

U.S. Pat. No. 1,201,957A discloses a hand truck having an axle arranged to slide along guide slots as the hand truck is tilted, and a latching mechanism for enabling the hand truck to be more readily manoeuvred while in an upright position during loading.

No means for providing a restoring force to assist in returning the hand truck to the upright configuration is disclosed.

According to a first aspect of the present invention, there is provided a hand truck, comprising: a frame; a platform for carrying a load; an axle; at least one wheel mounted on the axle; axle guide means; and biasing means, wherein at least a portion of the axle is moveable along the axle guide means to move the axle relative to the platform, and wherein the biasing means is configured to be compressed by tilting the frame towards a surface on which the hand truck is disposed to bias the axle away from the platform.

By providing a hand truck which has an axle moveable along axle guide means to move the axle relative to the platform, tilting of the hand truck from an upright position to a tilted, transport position for transporting a load enables the axle to move towards the load, which decreases the magnitude of the moment required to tilt the hand truck. This therefore provides the advantage of enabling a user to exert a lower force to tilt the hand truck for a given load.

By providing such a hand truck with biasing means configured to be compressed by tilting of the handles of the hand truck towards the ground to bias the axle away from the platform, a restoring force is provided due to compression of the biasing means in contrast to expansion of the biasing means, thereby providing the advantages of reducing the likelihood of failure of the biasing means and of reducing the required size of the biasing mechanism for providing a given restoring force.

This also provides a biasing force which can be arbitrarily chosen by a user of the hand truck, thereby enabling a user to tailor the moment required to tilt the hand truck to a particular angle, and therefore provides the advantage of enabling the hand truck to be adaptable to users of different heights and strengths.

The biasing means may be further configured to become incompressible responsive to tilting of the hand truck, thereby providing a hard stop. For example, having been compressed by the action of a sufficiently compressive force, the turns of a helical spring will contact one another and present a rigid and incompressible object rather than a pliant and compressible object. This provides the advantage that the tilting characteristics of the hand truck can be tailored, thereby increasing the safety of the hand truck. For example, in anticipation of a particularly heavy load, a biasing means may be chosen which travels a relatively short distance under load before becoming incompressible, thereby enabling easier initial tilting of the hand truck while preventing the hand truck from tilting beyond a tilt angle which may present a danger to the user.

The axle guide means may define a channel in which at least a portion of the axle is slideable.

This provides the advantage of a simple and inexpensive mechanism for enabling guidance of the axle as it moves relative to the platform.

The axle may be journaled in an axle sleeve. At least a portion of the axle sleeve may be slideable in the channel.

This provides the advantage of reducing wear of the axle due to friction.

The biasing means may be attachable to the axle and at least one of: (i) the frame; (ii) the platform; and (iii) the axle guide means.

This provides the advantage of increasing ease of manufacture of the device.

The biasing means may be arranged inside the axle guide means.

This provides the advantage of protecting the biasing means from damage, such as environmental damage.

The biasing means may comprise at least one spring.

This provides the advantage of a simple and inexpensive mechanism for adapting the hand truck to different users.

The hand truck may further comprise tensioning means for adjusting the tension of said at least one spring.

This provides the advantage of enabling the tension of the spring to be adjusted. If the spring is completely tensioned to the point at which it acts as a hard stop, the hand truck effectively becomes a standard hand truck. This has the advantage of lifting the base plate to its largest extent to enable the hand truck to be moved along particularly uneven ground. Furthermore, depending on the weight of a load, the user might wish to increase the tension in the spring to provide a required level of cushioning effect when moving the hand truck up or down stairs.

Said tensioning means may comprise at least one screw.

The biasing means may be releasably attachable.

This enables the same hand truck to be adaptable to different users, thereby increasing adaptability of the hand truck.

The hand truck may further comprise at least one protrusion, located on the platform, wherein the protrusion is arranged to grip a portion of a load in use.

This increases the stability of a load placed on the platform during tilting and motion of the hand truck, thereby providing the advantages of preventing damage to the load and increasing user safety. For example, this enables safe handling of heavy loads such as gas canisters, which can be gripped by the protrusion.

The platform may be releasably attachable to the frame.

This enables platforms of different types to be attached to the frame, thereby providing the advantage of enabling the hand truck to be used for different load types.

According to a second aspect of the present invention, there is provided a hand truck assembly, comprising: a hand truck according to the first aspect of the present invention, and at least one rigid rod, attachable to the axle and at least one of: (i) the frame; (ii) the platform; and (iii) the axle guide means, wherein the biasing means is arranged to bias the axle away from the platform.

By providing such an assembly, the moment required to tilt the hand truck may be arbitrarily chosen by a user, thereby providing a hand truck of increased adaptability.

The hand truck assembly may further comprise at least one platform releasably attachable to the frame.

Embodiments of the present invention will now be described, by way of example only and not in any limitative sense, with reference to the accompanying drawings, in which:

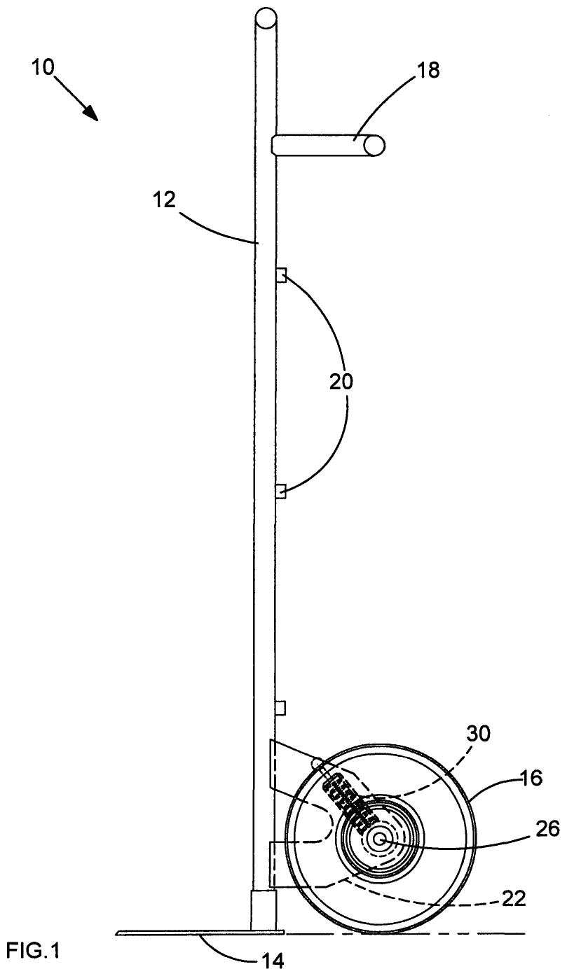

FIG. 1 shows a side view of a hand truck of a first embodiment of the present invention in an upright position;

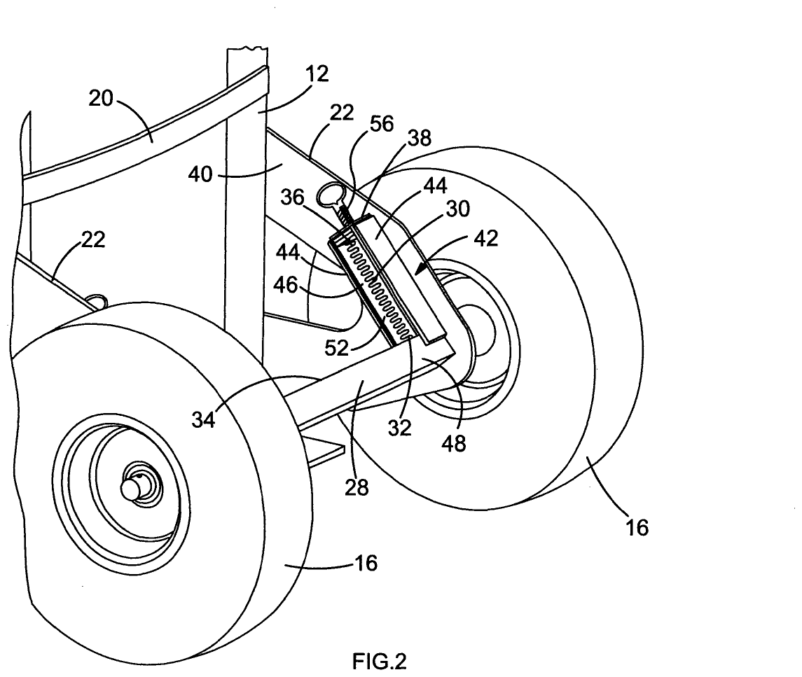

FIG. 2 shows a close-up perspective view of the hand truck of FIG. 1 in the upright position;

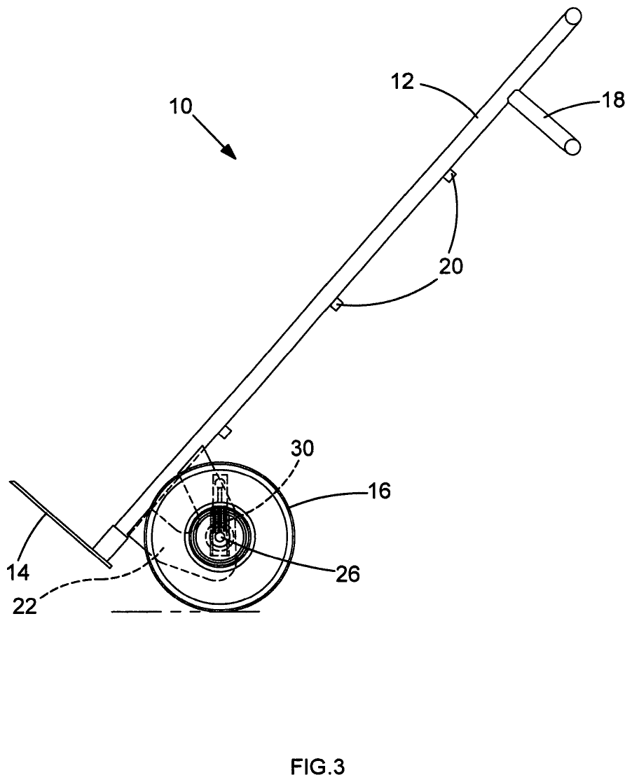

FIG. 3 shows a side view of the hand truck of FIG. 1 in a tilted position;

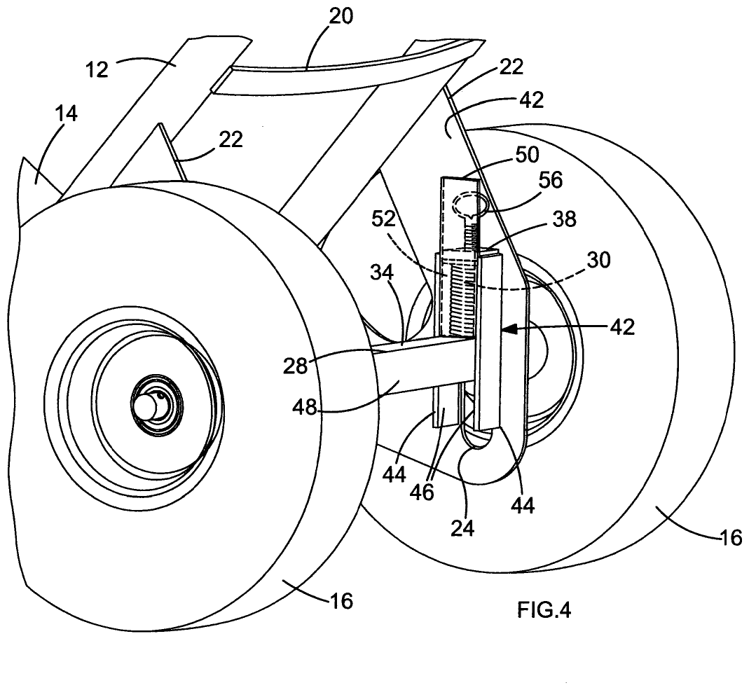

FIG. 4 shows a close-up perspective view of the hand truck of FIG. 1 in the tilted position;

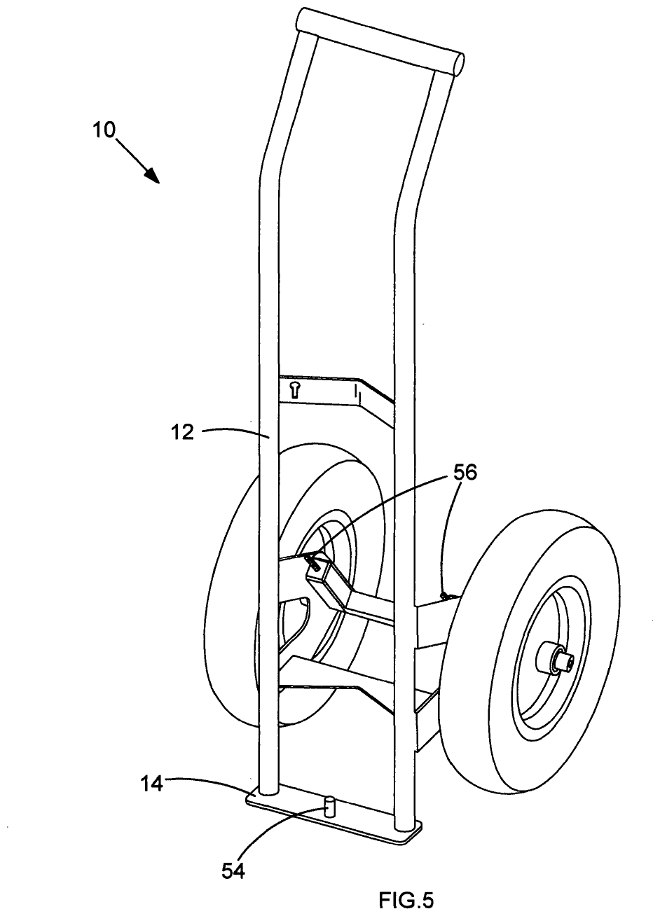

FIG. 5 shows a perspective view of a second embodiment of the present invention;

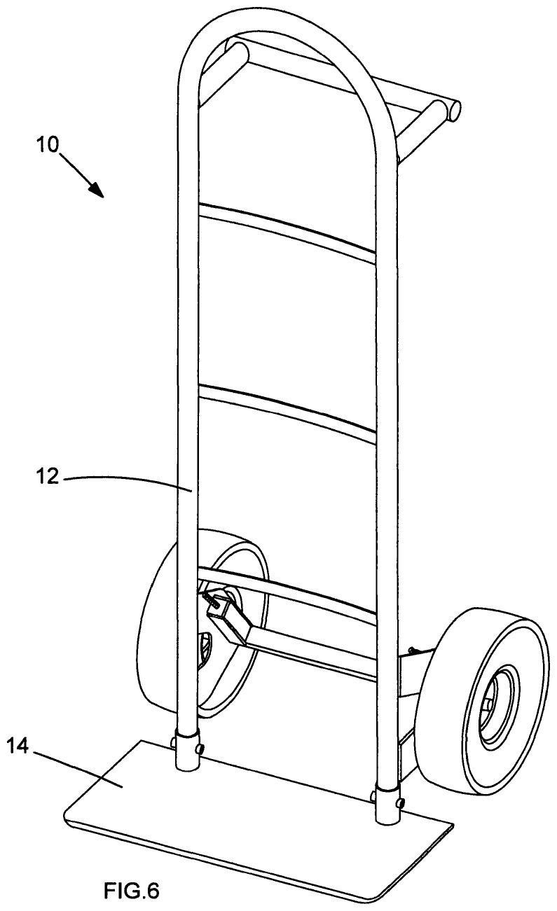

FIG. 6 shows a perspective view of a third embodiment of the present invention;

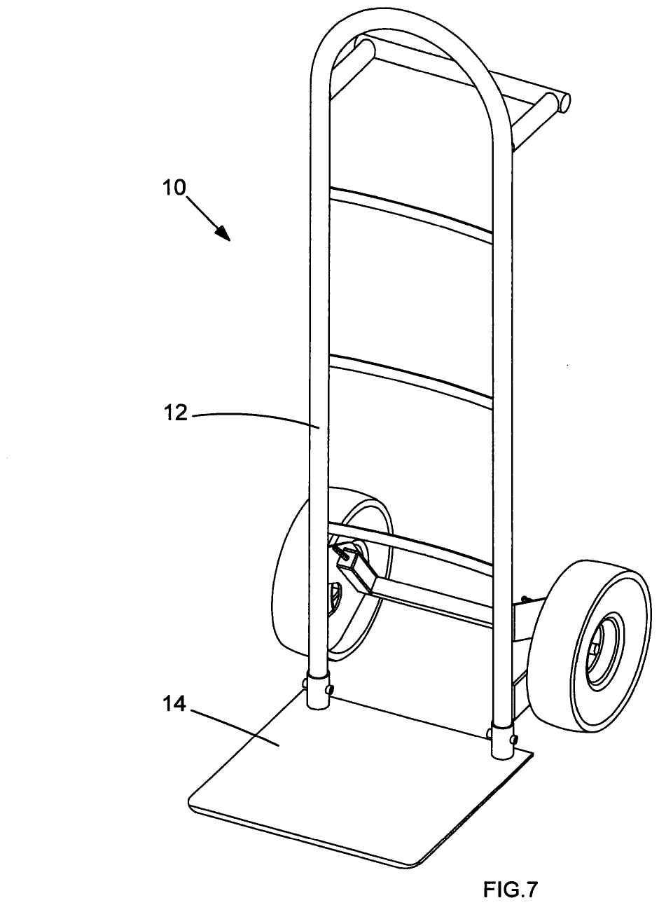

FIG. 7 shows a perspective view of a fourth embodiment of the present invention; and

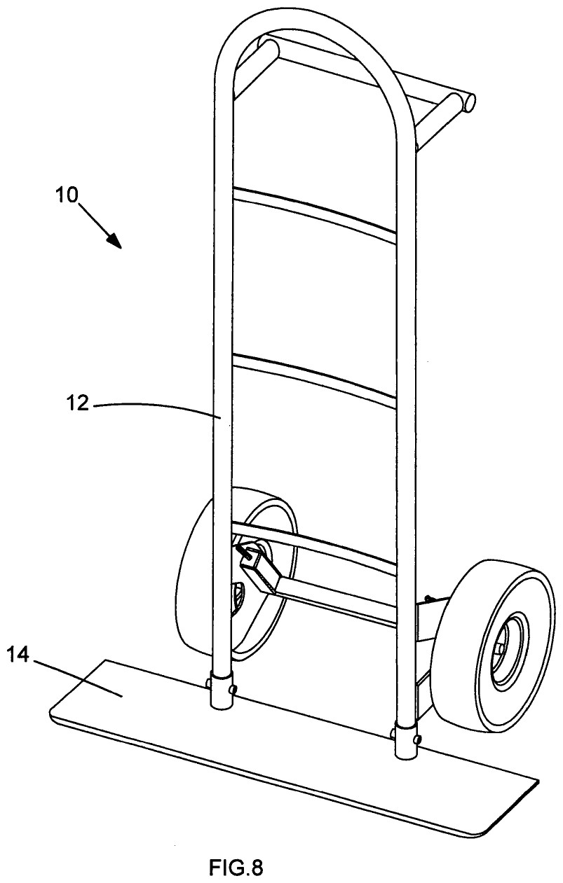

FIG. 8 shows a perspective view of a fifth embodiment of the present invention.

10: hand truck
12: frame
14: platform
16: wheels
18: handle
20: struts
22: U-shaped portions
24: aperture
26: axle
28: axle sleeve
30: springs
32: first ends of springs
34: face of axle sleeve
36: second ends of springs
38: end plates
40: inside surfaces of U-shaped portions
42: axle guide means
44: axle guide members
46: inner surfaces of axle guide members
48: outer surfaces of the axle sleeve
50: cover plates
52: channels
54: protrusion
56: spring tensioning screw

Referring to FIGS. 1 to 4, a hand truck 10 according to a first embodiment of the present invention is shown. FIGS. 1 and 2 show the hand truck 10 in an upright position, in which the hand truck 10 is ready to receive a load, while FIGS. 3 and 4 show the hand truck 10 in a tilted position, in which the hand truck is either ready to be moved or is in the process of being moved by a user.

The hand truck 10 is shown having a frame 12, a platform 14 for receiving and carrying a load at an end of the frame 12, and two wheels 16 rotatable about axle 26.

The frame 12 has a handle 18 at an end of the frame 12 distant from the platform 14, a number of laterally-arranged struts 20 for providing support to a load, and two U-shaped portions 22 extending outwardly from the frame 12 on a side of the frame 12 opposite the platform 14. In an embodiment, the U-shaped portions 22 are mirror-images of one another. The U-shaped portions 22 are shown each having an aperture 24 for passage of an axle 26. The apertures are shown having an elongate shape.

The hand truck 10 is shown having two wheels 16 arranged on an axle 26. The axle 26 is shown journaled through an axle sleeve 28 of square cross-section. Axle sleeves of other cross-section shapes are possible, and cross-section shapes having one or more flat faces for engagement with the one or more springs or other biasing means present a greater surface area for more stable engagement. The axle 26 is shown passing through the elongate apertures 24 of the respective U-shaped portions 22 of the frame 12.

Biasing means in the form of two springs 30 are shown located at opposite ends of the axle sleeve 28. Springs 30 are formed from metal. First ends 32 of the two springs 30 are attached to a face 34 of the axle sleeve 28. Second ends 36 of the two springs 30 are attached to respective end plates 38 which are fixed to, and protrude inwardly from, the corresponding U-shaped portions 22. The biasing means 30 is configured to be compressed by tilting the frame 12 towards a surface on which the hand truck is disposed, such as the ground, to bias the axle 26 away from the platform 14.

It should be understood that biasing means other than coil springs could be used. For example, gas springs or rubber rods would also provide similar advantages to compressible metal springs.

Fixed to an inside surface 40 of each U-shaped portion 22 is an axle guide means 42 comprising two axle guide members 44 arranged either side of the axle sleeve 28 to define respective channels 52 such that the inner surfaces 46 of the axle guide members 44 are proximal to respective outer surfaces 48 of the axle sleeve 28. The axle guide members 44 are arranged on each respective U-shaped portion 22 so as to guide the axle sleeve 28 to move along the axle guide members 44 so that the axle sleeve 28 slides along the channels 52. The springs 30 are shown positioned between each respective pair of axle guide members 44 within respective channels 52, where the end plates 38 to which the springs 30 are attached are shown located adjacent respective ends of the pairs of axle guide members 44.

Referring to FIGS. 2 and 4, cover plates 50 are shown located adjacent respective pairs of axle guide members 44, slidably received in grooves thereof and adjacent the axle sleeve 28 so as to enclose the respective springs 30. As illustrated by a comparison of FIGS. 2 and 4, the cover plates 50 are arranged to be fixed relative to the axle sleeve 28 and to be moveable relative to the axle guide members 44.

Referring to FIGS. 2, 4 and 5 a spring tensioning means in the form of spring tensioning screw 56 is provided for each spring 30. The spring tensioning screw 56 can be rotated to adjust the tension of springs 30. If the springs are tensioned to their fullest extent so that they are unable to compress any further, the hand truck effectively becomes a standard hand truck. In this condition, the platform 14 is lifted to its fullest extent from the ground which is useful for moving along bumpy ground.

Alternatively, if spring tensioning screw 56 is rotated such that the spring is at its least compressed condition, this provides a large amount of cushioning when moving a load. If a user wishes to move a load up and down stairs, depending on the weight of the load, the spring tensioning screw 56 can be rotated to provide a required level of cushioning for a weight of load that assists in moving up and down stairs. For example, for a light load, it has been found that a small amount of tensioning is useful. On the other hand, for a heavy load, a large amount of spring tensioning can be chosen by rotation of the spring tensioning screw 56. A large amount of pre-tensioning in the spring also makes it more difficult to tilt the hand truck.

While this embodiment of the present invention is shown and described as having two springs, it is to be understood that further embodiments having one spring, or more than two springs, or no spring, are possible.

Referring to FIG. 5, a second embodiment of the present invention is shown in the form of a hand truck 10 having a frame 12 and a platform 14. The platform has a protrusion 54 protruding upwardly from the platform 14 for gripping a portion of a gas canister when the gas canister is loaded onto and transported by the hand truck 10.

Referring to FIGS. 6 to 8, third, fourth, and fifth respective embodiments of the present invention are shown. Each of these embodiments is in the form of a hand truck 10 having a frame 12 and platform 14, wherein each platform 14 is releasably attachable to the frame 12, and is otherwise substantially identical to the first embodiment. However, it is to be understood that the second embodiment may also have a releasably attachable platform.

In use, a load is placed on the platform 14 while the hand truck 10 is in the upright position. A user, wanting to transport the load, pulls the handle 18 of the hand truck 10 so as to rotate the hand truck 10 from the upright position to a tilted position at an angle suited to the user. As the hand truck 10 is tilted by the application of a moment by a user, the axle 26 moves along the axle guide members 44 toward the frame 12 whilst compressing springs 30, and therefore toward the load. This causes the fulcrum of the rotation to be moved toward the frame 12, and therefore toward the load. As a result of moving the fulcrum closer to the load, the moment required to lift the load during rotation is reduced for a given load, thereby reducing the magnitude of force a user is required to provide in order to tilt the hand truck 10 from the upright to the tilted position.

In the tilted position as shown in FIGS. 3 and 4, the spring travel in the axle guide means 42 can be chosen to be sufficient such that the hand truck can come to rest in a tilted position without being held by the user in which the hand truck is supported on the ground by the edges of U-shaped portions 22. This provides the advantage that the hand truck can be left in a condition ready for removal. When a load has been moved to a required location, a user pushing handle 18 upwardly is assisted by the restoring force of the springs 30 moving from their compressed to uncompressed conditions.

Springs of different strengths can be used to tailor the biasing force resisting relative motion of the axle sleeve 28 and the load. For example, no spring may be used, thereby minimising the moment required to tilt a given load and enabling a greater tilt angle for transport by a shorter or less strong user, or a stiff spring may be used, to enable a stronger or taller user to transport the load at a lesser tilt angle.

Furthermore, springs of different strengths and shapes may be selected to tailor at what combination of load and tilting angle the hard stop of the spring is reached. The springs further serve as suspension when transporting the hand truck over bumpy ground or up or down stairs, increasing the comfort and safety of the user. Furthermore, one or more rigid rods, such as metal bars, of appropriate dimensions can be placed between the axle sleeve 28 and one or more of the end plates 38 to prevent relative motion of the axle sleeve 28 and the load.

During a demonstration comparing two examples of the present invention, wherein the first of the two examples had two rigid rods placed along the axle guide members 44 to prevent relative motion of the axle sleeve 28 and the load and the second of the two examples replaced the rigid rods with springs 30, it was found that the force required to lift a given load and tilt the hand truck 10 to a given angle was reduced from 20 Newtons in the case of the first examples to 8 Newtons in the case of the second.

It will be appreciated by those skilled in the art that the above embodiments have been described by way of example only, and not in any limitative sense, and that various alterations and modifications are possible without departing from the scope of the invention as defined by the appended claims. For example, the wheels of the hand truck can be mounted on farther apart from one another on the axle to increase the stability of the hand truck.

1. A hand truck, comprising:
a frame;
a platform for carrying a load;
an axle;
at least one wheel mounted on the axle;
axle guide means; and
biasing means,
wherein at least a portion of the axle is moveable along the axle guide means to move the axle relative to the platform, and wherein the biasing means is configured to be compressed by tilting the frame towards a surface on which the hand truck is disposed to bias the axle away from the platform.

2. The hand truck of claim 1, wherein the biasing means is further configured to become incompressible responsive to tilting of the hand truck, thereby providing a hard stop.

3. The hand truck of claim 1, wherein the axle guide means defines a channel in which at least a portion of the axle is slideable.

4. The hand truck of claim 3, wherein the axle is journaled in an axle sleeve and at least a portion of the axle sleeve is slideable in the channel.

5. The hand truck of claim 1, wherein the biasing means is attachable to the axle and at least one of:
i. the frame;
ii. the platform; and
iii. the axle guide means.

6. The hand truck of claim 1, wherein the biasing means is arranged inside the axle guide means.

7. The hand truck of claim 1, wherein the biasing means comprises at least one spring.

8. The hand truck of claim 7, further comprising tensioning means for adjusting the tension of said at least one spring.

9. The hand truck of claim 8, wherein said tensioning means comprises at least one screw.

10. The hand truck of claim 1, wherein the biasing means is releasably attachable.

11. The hand truck of claim 1, further comprising at least one protrusion, located on the platform, wherein the protrusion is arranged to grip a portion of a load in use.

12. The hand truck of claim 1, wherein the platform is releasably attachable to the frame.

13. (canceled)

14. The hand truck assembly of claim 19, wherein the platform is releasably attachable to the frame.

15. The hand truck of claim 2, wherein the axle guide means defines a channel in which at least a portion of the axle is slideable.

16. The hand truck of claim 2, wherein the biasing means is attachable to the axle and at least one of:
i. the frame;
ii. the platform; and
iii. the axle guide means.

17. The hand truck of claim 2, wherein the biasing means is arranged inside the axle guide means.

18. The hand truck of claim 2, wherein the biasing means comprises at least one spring, and wherein the hand truck further comprises tensioning means for adjusting the tension of said at least one spring.

19. A hand truck assembly, comprising:
a hand truck, including
a frame,
a platform for carrying a load,
an axle,
at least one wheel mounted on the axle,
axle guide means, and
biasing means,
wherein at least a portion of the axle is moveable along the axle guide means to move the axle relative to the platform, and wherein the biasing means is configured to be compressed by tilting the frame towards a surface on which the hand truck is disposed to bias the axle away from the platform; and
at least one rigid rod, attachable to the axle and at least one of:
i. the frame;
ii. the platform; and
iii. the axle guide means.

20. The hand truck assembly of claim 19, wherein the biasing means is further configured to become incompressible responsive to tilting of the hand truck, thereby providing a hard stop.

21. The hand truck assembly of claim 19, wherein the biasing means comprises at least one spring, and wherein the hand truck further includes tensioning means for adjusting the tension of said at least one spring.
